(19) United States
(12) Patent Application Publication
(10) Pub. No.: US 2024/0018756 A1
(43) Pub. Date: Jan. 18, 2024

(54) APPARATUS FOR ABSORBING PRECIPITATION WATER AND FOR WATER EVAPORATION

(71) Applicant: Universität Stuttgart, Stuttgart (DE)

(72) Inventors: Christina EISENBARTH, Stuttgart (DE); Walter HAASE, Hildrizhausen (DE); Werner SOBEK, Stuttgart (DE)

(21) Appl. No.: 18/031,950

(22) PCT Filed: Jun. 18, 2021
(86) PCT No.: PCT/EP2021/066687

§ 371 Date: Apr. 14, 2023

(30) Foreign Application Priority Data
Oct. 16, 2020 (DE) 10 2020 127 367.3

(51) Int. Cl. E03B 3/02; E03B 1/04

(52) U.S. Cl. CPC E03B 3/02; E03B 1/041; E03B 2001/047

(57) ABSTRACT

The invention relates to an apparatus for absorbing precipitation water from rain events, especially from driving rain events, and for water discharge by evaporation, wherein at least one textile element for absorbing water from rainwater drops and/or for discharging water by evaporation is provided, wherein the textile element is designed as or embodies a three-dimensional textile structure, with a first, water-permeable layer and a second, water-guiding layer, wherein these layers are connected to one another by means of water-guiding connecting threads, wherein the textile element is preferably fluidically connected via a water discharge conduit to a water collecting device and/or via a water supply conduit to a water supply device.

The invention relates to an apparatus for absorbing precipitation water from rain events and for water discharge by evaporation. Furthermore, the invention relates to usage of such an apparatus as a construction element in, on or outside of a building or civil engineering structure and as well as to the usage of at least one such apparatus on or in the facade of a new or existing building. Additionally, the invention relates to a (multi-layer) facade system for separating a building interior from an exterior space integrating such apparatus. Finally, the invention relates to a method for operating such apparatus or (multi-layer) facade system in, on or outside a building as well as to a method for controlling and/or regulating an apparatus for absorbing and discharging (precipitation) water. The above-described method may optionally include a software.

In and on buildings, precipitation water is usually drained off in such a way that precipitation water hitting the facade or the roof of a building, that separates the interior from the exterior of the building, is drained, for example in gutters, and fed into the sewage system. This allows drainage of precipitation water, at least under normal weather conditions.

In view of a growing world population and urbanization, as well as increasing climatic impacts on urban structures due to more extreme weather conditions such as heat and heavy rain, there is a need for new possibilities, methods and systems to reduce climate-related risks, especially, to reduce risks of flooding and heat stress.

Ongoing urbanization and re-densification raise the percentage of sealed areas and increase the risk of flooding in urban areas. Due to the densification of urban space, sealed areas with runoff effect are connected more and more to the existing sewage infrastructure. Therefore, the hydraulic capacity of conventional sewage systems is often exceeded in case of heavy rainfall events leading to a risk of flooding with significant material damage and personal injury. The consequences range from selective overflow in road space to severe flooding of entire streets and damages to infrastructures and buildings. Redimensioning the existing sewage systems, if at all possible, would entail a huge amount of work and costs.

Additionally, absorption of solar energy on sealed road and building surfaces in the city leads to a significant increase of air temperature, which will analogously rise in the future due to global warming. So-called “Urban Heat Islands” are generated that, apart from heat stress, pose a health hazard especially to older people.

Both extremes (flooding and heat stress) are further amplified by climate change. According to forecasts, increased heavy rainfall events with intensities far above the prescribed rainfall limits as well as a significant temperature rise with coherent increasing number of hot days are to be expected in the future. Retention areas for decentralized infiltration of rainwater are therefore urgently required particularly in dense urban zones.

To reduce the impact on the sewage system and to improve the microclimate, the so-called “sponge city” concept is promoted internationally, which provides an increasingly decentralized collection, retention and evaporation of precipitation water in the area or in special reservoirs such as trough-trench systems, green roofs, etc. Based on DIN 1986-10 standard, in order to avoid an overloading of the public sewage system, local authorities can limit the maximum rain runoff or prescribe retention options on the site. However, open cavities for decentralized infiltration measures such as trough-trench systems generally consume a large amount of space that cannot be provided in urban, highly dense settlement or inner-city structures. In this case, the surfaces of buildings such as the facades are of particular importance for improving urban rainwater and temperature management.

From prior art, conventional methods for rainwater harvesting through rain gutters and similarly functioning collecting systems in the facade area are also known. These systems have only low efficiency with high material requirements and low water yields due to rebound of rainwater drops on “hard surfaces”.

Green facade systems are also known from the state of the art, but are to be considered critical due to their high maintenance intensity caused by a constantly necessary water and nutrient supply. The precipitation water hitting the facade is usually not sufficient to maintain the functionality of green facade systems and the storage capacity of water in vertical applications is significantly lower than in horizontal roof areas. In addition, due to the susceptibility to frost and dew changes as well as mechanical stresses, replanting is often necessary, which is particularly difficult to realize in high-rise buildings, which also argues for their application in the roof area or in the facade of lower buildings.

Spacer fabrics also known as 3D-textiles characterized by two outer layers of preferably knitted fabric that are connected to each other via an intermediate spacer structure of monofilament or multifilament spacer threads are well known from previous state of the art (DE000009016062U1, DE000004239068A1, DE000004317883A1 and following) for their application only in upholstery.

Textiles with evaporative cooling effect for clothing sector are known from prior art e.g. from inventions DE102004002287A1, EP000001555489A2, DE102011014383A1, EP000002380534A1, EP000002560591B1, W0002011131718A1 and further. Whereas textile-based building components with evaporative cooling function are not known.

DE 10 2008 042 069 A1 is the only document that focuses on water collection via three-dimensional textile structures disclosing an apparatus for obtaining water from fog, with a textile separating element for separating liquid particles contained in an aerosol, wherein the separating element is formed as a three-dimensional textile structure. This allows small amounts of drinking water to be obtained from fog, for example in dry areas. The functions and applications of the above described invention distinguish clearly from the above invented apparatus for absorbing precipitation water and for water evaporation.

However, the state-of-the-art shows that there is no multifunctional, mutually beneficial invention for the collection e.g. the retention of precipitation water as well as for the water discharge e.g. an evaporative cooling of the surrounding urban area by means of a textile construction element, which is urgently needed in view of the above-mentioned global climatic challenges.

It is an objective of the invention to reduce the risk of urban heat and flooding as well as the danger of damages and personal injuries caused by these events, especially in urban areas. Acutely needed are concepts for decentralized rainwater retention and water evaporation, which contribute effectively and economically to an improvement of urban rainwater and temperature management to be applied on building surfaces and other civil engineering structures. Furthermore, it is desirable to use precipitation water for intelligent water consumption in, on or outside of buildings in terms of ecological and economical purposes e.g. to reduce water and energy consumption for users in or around the building and/or for interior room conditioning or other building specific uses.

The invention achieves the above-mentioned object by an apparatus according to claim 1.

The invention relates to an apparatus for absorbing precipitation water from rain events, especially from driving rain events with a horizontal velocity component e.g. caused by wind and for water discharge by evaporation.

The apparatus is characterized by at least one textile element for absorbing water (textile element acting as a collector element) from rainwater drops (e.g. having a horizontal velocity component) and/or for discharging water (provided by the public water supply network) and/or precipitation water (absorbed by the apparatus described above) by evaporation (textile element acting as an evaporator element). The textile element is designed as or embodies a three-dimensional textile structure with a first, water-permeable layer (outer layer) and a second, water-guiding layer (inner layer). The first layer and the second layer are connected to one another by means of water-guiding connecting threads. The textile element is preferably fluidically connected to a water discharge conduit and/or to a water supply conduit.

The proposed apparatus can act as an absorber device and as an evaporator device as well, wherein the absorber and evaporator are one identical, multifunctional device (one hybrid integrated system). In case of rain or driving rain events with a horizontal velocity component e.g. caused by wind, deflecting the raindrops from the vertical fall direction, precipitation water can be absorbed, stored and/or discharged by evaporation, if necessary with a time delay, or can be otherwise used in, on or outside the building. When absorbing, precipitation water is led from the first, water-permeable layer along the connecting threads (spacing structure) to the second, water-guiding layer for collection. When discharging water for evaporation and evaporative cooling of the exterior, the water is led from the second, water-guiding layer along the connecting threads (spacing structure) to the first, water-permeable layer.

The absorption, storage and/or targeted, time-delayed discharge of precipitation water, in particular water discharge by evaporation, offer significant economic and ecological advantages in, on or outside a building as well as on a district and urban level.

It is possible to reduce the risk of flooding and heat stress in urban areas, as precipitation water can be absorbed and stored to be then, e.g. with a time delay, discharged into the environment by evaporation or used for other purposes. By absorbing and storing precipitation water, the apparatus acts as a retention surface for rainwater. This allows the drainage of heavy rainfall to be delayed in order to significantly reduce the risk of overloading the sewer system during extreme weather events. By discharging water to the environment via evaporation, the environment can be cooled, thus reducing the effect of heat loads.

A reduction of the building's internal water demand can also be achieved. By collecting precipitation water and making it available as raw water inside, on or outside the building, for example for toilet flushing, washing machine use and/or plant irrigation, water consumption can be significantly reduced.

Furthermore, if the apparatus is installed in or on a high-rise building, the possibility of harvesting raw water in the building skin by the apparatus leads to a reduction of water pump energy consumption. Otherwise water is provided by public water supply network and pumped to the corresponding building floor level. In multi-storey or high-rise buildings (e.g. skyscrapers) in particular, the water collection in the building facade leads to a considerable reduction of the with rising building height exponentially increasing material and pump energy consumption. For the advantageous use of rainwater in, on or outside the building, the apparatus can thus achieve considerable economic savings.

Finally, the collected rainwater by the apparatus may also be purified to drinking water and/or be used for comfort optimization of the interior (temperature and/or humidity regulation, acoustic and sound optimization) and/or for active fire protection measures.

In the context of this invention, evaporation describes the phase transition of water from a liquid aggregate state to a vaporous aggregate state by releasing cooling energy. Thus, absorption is understood as the collection and transfer of a liquid.

The three-dimensional textile structure e.g. spacing structure also known from previous state of the art as a 3D-textile or spacer fabric comprises a double-faced material, whose surfaces are kept at a distance by connecting threads of monofilaments or multifilaments that connect one surface to another.

With regard to the textile element and/or to the three-dimensional textile structure, “textile” does not mean a material-technical restriction to certain materials, but only refers to the macroscopically recognizable technical structure.

Within the scope of the invention, a facade or a facade element is understood to be a building boundary e.g. an outer building hull or an element thereof that delimits a building laterally, i.e. on the building (side) walls and thereby separates a building interior (inside) from an exterior space (outside).

To be differentiated are solid (facade) constructions that are part of the supporting structure e.g. concrete, brick and/or wooden constructions and frame constructions e.g. steel structures as supporting, load bearing and/or load transferring components with an outer non-supporting curtain wall e.g. a multi-layer textile facade system.

The apparatus in combination with or without an insulation layer for thermal and acoustic damping purposes with or without at least one fluid-flow-through layer comprising a functional textile layer with cavities and internal watertight impermeable impregnation for the flow of liquid media with or without an inner layer forming the inner closure facing the building interior to be hold in a preferably modular profile system is specified as a multi-layer preferably hydroactive and/or adaptive facade system.

Within the scope of this invention, “adaptive” means an automatic adjustment of a building, a civil engineering structure, or components thereof e.g. of the apparatus (10), a facade or the multi-layer facade system (100) to varying environmental conditions operated by integrated sensors, actuators and a control unit obtaining a method for operating and/or regulating the system.

This method for operating, controlling and/or regulating is referred as a systematic procedure i.e. the description of a logical sequence of steps, e.g. the execution of one or several measurements to reach the desired aim of an ecologic and economic water use. The method may include a software e.g. a program.

“Hydroactive” in this context means the ability of surfaces to absorb moisture or water and/or to release it with a time delay.

The side facing the weather e.g. the rain, in other words facing the exterior space (environment) of the apparatus and/or of a multi-layer facade system is referred to as the “outside” (“O”) in the following.

The side facing the building, in other words facing the building interior of the apparatus and/or of a multi-layer facade system is referred to as the “inside” (“I”) in the following.

A civil engineering structure, to which the apparatus inter alia can be applied, can e.g. be a bridge, a tower, a windmill or the like. Complementary to civil engineering structures, buildings in this context are understood as independently usable, covered constructional facilities to be differentiated between one-storey and multi-storey buildings (house with two or more floors) e.g. high-rise buildings or skyscrapers, in which the floor of at least one room is more than 22 meters above the defined ground surface level.

Within the scope of this invention, water in general includes raw water that can be absorbed, stored or processed e.g. absorbed, filtered precipitation water and non-contaminated grey water as well as drinking water supplied e.g. by public water supply network.

Raw water is water from the environment that has not been treated and without treatment is unsafe for human consumption. Raw water includes precipitation water or rainwater e.g. water from clouds, fog, or vapour that due to gravity drops to earth in liquid form. Wherein driving rain events are characterized by a horizontal velocity component, deflecting the raindrops e.g. by wind from the vertical fall direction. Raw water can only be used e.g. for plant watering, cleaning purposes, washing machine operation and/or toilet flushing and is the opposite to drinking water e.g. fresh potable water for human consumption or waste water, one say contaminated water from toilet flushing, dishwashers, etc. Waste water has to be distinguished between contaminated precipitation water, black water and non-contaminated grey water without fecal contamination from baths, showers, washing machines etc. Non-contaminated grey water can be treated and reused for non-potable uses referring to raw water.

Finishings in the context of textile manufacturing e.g. chemical finishings for UV or fire resistance are measures for upgrading textile fabrics, yarns and fibres in order to optimize the material properties. In addition, coatings comprise the application of solid or liquid material e.g. nanocoating to a substrate fabric whereas lamination describes the bonding or fusing of a multi-layer fabric containing at least one textile with further layers of textile, plastic or metal films, foam or other appropriate material.

3D-Printing in the sense of the invention means the action or process of making a physical object from a three-dimensional digital model, typically by laying down many thin layers of a material in succession. Distinction is made between subtractive and additive manufacturing methods e.g. textile printing methods such as additive 3D printing via Fused Deposition Modelling (FDM) or Fused Filament Fabrication (FFF) with thermoplastic polymers or metals or other appropriate materials on a textile substrate fabric.

In an advantageous way, a water collecting device can be provided which is flow-connected to the textile element and/or to the water discharge conduit. The water collecting device can be embodied as a water storage, e.g. a water storage tank and/or a fluid-flow-through layer in the multi-layer facade system. Thus, precipitation water hitting the textile element can be absorbed, collected and/or stored in the water collecting device.

The water collection or water drainage (water outflow) can comprise a reservoir, basin, gutter or the like that may be integrated in the water collecting device e.g. in the (lower) frame profile and/or connected to a water storage of the water collecting device e.g. a water storage tank, a fluid-flow-through layer in the multi-layer facade system and/or other components for collecting, storing and/or treating e.g. for filtering water, as well as corresponding conduits for water transport.

The water discharge conduit can be flow-connected downstream to the textile element. Precipitation water absorbed by the apparatus can be drained off via the water discharge conduit and fed to a water consumer and/or to the water collecting device e.g. to a water storage. Collected water can be discharged directly or after a period of time (storing time).

In an appropriate manner, a water supply device can be provided which is flow-connected to the textile element and/or to the water supply conduit.

The water supply or water supply device, the delivery of (precipitation) water, can comprise a gutter, a pipe, a tube, an inflow line, a funnel or the like that may be integrated in the (upper) frame profile as well as corresponding conduits for water transport. Also, the water supply device may be configured as punctual or linear water injections on the second layer side of the textile element of the apparatus facing the building interior (inside) I, e.g. by water jets, (perforated) pipes or hoses or a perforated fluid-flow-through layer connected to the textile element.

The water supply conduit can be flow-connected upstream to the textile element. Water, e.g. supplied by public water supply network or absorbed water (former precipitation water absorbed by the apparatus), can be provided to the textile element by means of the water supply conduit to be discharged into the environment by evaporation.

In an advantageous way, the textile element i.e. the three-dimensional textile structure can preferably be formed from synthetic and/or polymer fibre (e.g. polyethylene (PE) fibre, polyester (PES/PET) fibre, polypropylene (PP) fibre, polyamide (PA) fibre, polytetrafluorethylene (PTFE) fibre, ethylene tetrafluoroethylene (ETFE) fibre or the like), from glass fibre, metal fibre and/or other appropriate materials, wherein these materials are embodied as monofilaments or multifilaments. The filaments may be optimized in shape by means of a specific functionalized filament profile, e.g. a spiral shape for better water transport. Thereby, a UV- and fire-resistant textile structure with good water-bearing properties can be achieved.

In an appropriate manner, the apparatus and/or the textile element can comprise hydrophilic (water-attracting) and/or hydrophobic (water-guiding, water-repellent) modifications. Therewith, the functionality of the apparatus can be maximized. The hydrophilic and/or hydrophobic modifications can be embodied as laminations, coatings, finishings, filament shape optimizations (e.g. spiral shaped filament) and/or additive surface structures that are microstructured or macrostructured. Modification materials can for example be polytetrafluorethylene (PTFE), polyvinyl chloride (PVC), silicone, paraffin wax and/or nanocoatings like titanium dioxide (TiO2) and/or silicon dioxide (SiO2) or the like or combinations thereof. The hydrophilic and/or hydrophobic modifications can preferably achieve the following properties: achieving or optimizing water-guidance (water-repellence) and/or water-attraction for maximizing the effects of collecting and/or evaporating water, weather and dirt resistance, antimicrobiality with regard to mould, fungi and bacteria as well as self-cleaning properties.

In an advantageous way, the first layer of the textile element can have a water-attracting and/or hydrophilic lamination, coating, finishing and/or filament shape optimization (e.g. spiral shaped filament) and/or a (separate) water-attracting layer can be applied (additively) to the first layer. A water-attracting lamination, coating, finishing, filament shape optimization and/or a (separate) applied water-attracting layer favour absorption of precipitation water “inwards”, i.e. into the inside of the textile element. The (separate) layer and/or the first layer can be of finer-pored design than the spacing structure formed by the connecting threads between the first layer and the second layer of the textile element. By a finer-pored design of the first layer and/or the (separate) layer a filter function can be achieved. This prevents dirt, animals, plants or parts thereof from getting into the interior of the apparatus e.g. into the textile element. The finer-pored structure may comprise e.g. a multifilament or nonwoven fabric to encapsulate a higher amount of water, thus leading to more effective and economical evaporative cooling effect.

In an appropriate manner, the second layer of the textile element can have a water-guiding (water-repellent) and/or hydrophobic lamination, coating, finishing and/or filament shape optimization (e.g. spiral shaped filament) and/or a (separate) water-guiding (water-repellent) layer can be applied (additively) to the second layer. The (separate) layer and/or the second layer can be water-tight or perforated. With the (separate) layer and/or the second layer being water-tight, water flow is positively influenced, so that absorbed precipitation water doesn't exit the textile element on the second layer side of the textile element (absorbed precipitation water is kept within the textile element). A configuration with perforation favours entrance of water into the interior of the textile element from the second layer side. Perforation can be advantageous, for example, for a homogeneous wetting of the textile element in order to achieve an evaporative cooling of the exterior (e.g. of the facade, the air space close to the facade and/or the urban space). In case of a perforated configuration, the textile element can be flow-connected to a further water supply device on the second layer side facing the building interior (inside) I.

To improve evaporation behaviour, between the second layer of the textile element and the (separate) applied water-guiding (water-repellent) layer an additional, finer-pored textile layer for encapsulating more water, e.g. a multifilament and/or nonwoven fabric and/or a superabsorber or the like, facing the exterior space (outside) O of the apparatus can be applied, thus contributing to more homogeneous wetting and higher evaporative cooling while reducing water consumption.

The (separate) layer can be embodied by laminating a foil (e.g. polyethylene (PE) foil, polyester (PES/PET) foil, polyvinyl chloride (PVC) foil, polytetrafluorethylene (PTFE) foil, ethylene tetrafluoroethylene (ETFE) foil, polypropylene (PP) foil, polyamide (PA) foil, silicone foil, latex foil, metal foil or similar) and/or a plate (metal plate, glass plate, silicone plate, polymer plate or similar) or the like onto the second layer.

In an advantageous way, the apparatus and/or the textile element can be planar, curved (e.g. anticlastic, synclastic, concave or convex), folded and/or adaptable in shape. Thus, the apparatus can be optimized for specific application. Adaptable in shape means being adaptive to optimize water absorption and/or water evaporation for maximizing performance of the apparatus.

In an appropriate manner, the first layer and/or the second layer can be configured as being actuatable by one or more actuators provided along a direction parallel to the plane of the first or the second layer. Thus, the first layer and the second layer can be displaced relatively to one another. By selective actuation of the first layer and/or the second layer the orientation i.e. the inclination angle of the connecting threads can be changed to improve water absorption and drainage behaviour and/or water discharge and evaporation behaviour of the apparatus.

In an advantageous way, the apparatus and/or the textile element can comprise folding structures which divide the apparatus and/or the textile element into several foldable, folded (e.g. relatively to one another), pivotable and/or rotatable sections. By means of such folding structures, one can maximize the surface of the apparatus e.g. of the textile element in order to increase its functionality.

In an appropriate manner, the folding structures can have a mechanical substructure. This substructure e.g. of steel, wood, aluminium and/or polymer or the like or combinations thereof provides a reinforcement for the folding structures. Optionally the folding structures can be introduced into the textile element by means of additive and/or subtractive manufacturing methods e.g. (3D) printing on textile substrate fabric and/or by textile connecting devices e.g. sewing and/or thermal fixation or the like or combinations thereof.

In an advantageous way, actuators can be provided, by means of which the foldable, folded, pivotable and/or rotatable sections can be operated. In this way, the folding structures can be adjusted to the respective angle of impact of the precipitation water drops and/or to the solar incidence angle by reorientation and/or re-rotation of the individual sections. The reorientation and/or re-rotation of the sections of the apparatus and/or of the textile element can be operated in a manual or automatically in an adaptive way by integrating sensors, actuators and a control unit.

The actuators can for example be embodied as linear actuators and/or rotational actuators e.g. electronic actuators and/or hydraulic actuators and/or pneumatic actuators or the like. Thus, water absorption and drainage and/or water discharge and evaporation of the apparatus can be selectively and specifically regulated and improved. These measures help to ensure that as much (precipitation) water as possible can be absorbed and/or discharged to evaporate in and on the apparatus e.g. in and on the textile element.

In an appropriate manner, sensors can be provided, by means of which in particular climate and/or environmental data e.g. ambient temperature, humidity, solar radiation data, wind data (e.g. wind speed and/or wind direction) and/or rain data (e.g. amount of precipitation water, angle of impact of the precipitation water drops, particle size and/or fall velocity of precipitation water drops) can be recorded. This allows the ambient conditions (climate and/or environmental data) of the apparatus to be monitored, recorded and/or to be transferred to a control unit providing the automated regulation and/or adaptation of the apparatus and/or of the textile element.

In an advantageous way, a control unit preferably obtaining a software e.g. a program for operating and/or regulating the actuators can be provided, wherein the control unit is configured in such a way that the apparatus and/or the textile element and/or sections thereof are adjusted in regard to climate and/or environmental conditions (e.g. to the angle of impact of precipitation water drops to optimize absorbing behaviour and/or to the solar incidence angle to optimize evaporating behaviour). This helps to maximize the performance of the apparatus. The control unit can be configured to interact with one or several sensors collecting environmental and/or climate data (e.g. as stated above) and with actuators that actuate the first layer and/or the second layer of the textile element and/or with actuators that operate the foldable, folded, pivotable and/or rotatable sections of the apparatus and/or of the textile element. This allows the actuators to be operated and/or regulated by the control unit based on environmental and/or climate data gathered by the sensors. The operation of the apparatus and/or of the textile element can be monitored with one or several further sensors.

In an appropriate manner, a holding device can be provided to which the components of the apparatus are attached or attachable. Thus, the apparatus disclosed herein can be applied to a building or other civil engineering structures by means of such a holding device, one say a fixation to attach one component to another e.g. to mount the apparatus to a building or a civil engineering structure. Furthermore, the components of the apparatus are arranged relatively to each other. The holding device can be embodied linearly as a frame profile or punctually by other appropriate methods e.g. a frame profile can be attached to the holding device by mounting brackets.

As already indicated above, the water collecting device can comprise a frame profile and/or a water storage e.g. a storage tank for storing precipitation water. The textile element can be held linearly by the frame profile e.g. by welt edge (piping) connections and/or punctually and/or by other appropriate fixations. The frame profile can be integrated, connected and/or attached to the holding device. The water storage may be flow-connected with the frame profile, wherein the water storage can be integrated in the building or in the facade as a functional storage location in a multi-layer facade system.

In an appropriate manner, a filter for filtering precipitation water can be provided, wherein the filter is integrated into the textile element and/or arranged in or on the water collecting device e.g. in or on the frame profile and/or in the building. This allows the water to be filtered before it is stored or made available to consumer.

In an advantageous way, a pump and/or a water temperature control device for water heating and cooling can be provided, which are in flow connection with the water supply device and/or with the water collecting device. By means of the pump, water can be fed to the water collecting device e.g. a water storage tank or a fluid-flow-through layer in a multi-layer facade system and/or transported further e.g. inside, on or outside the building. In addition, the pump can be used to pump water to the water supply device. By means of the water temperature control device the water can be tempered, i.e. heated or cooled as required.

In an appropriate manner, the water supply device and/or the water collecting device can be connected to a heat exchanger. In this way, heat can be extracted from the water supply device and/or from the water collecting device or heat can be added as required. One part of the heat exchanger can be connected to the water collecting device (downstream of the textile element) and another part of the heat exchanger can be connected to the water supply device (upstream of the textile element), wherein the heat exchanger parts are connected to each other to interact with a further building component e.g. with a fluid-flow-through layer in a multi-layer facade system and/or with a further technical building equipment in, on or outside a building or civil engineering structure. Thus, heat can be exchanged between both heat exchanger parts.

The invention also achieves the above-mentioned object by usage of an apparatus according to one or more of the above aspects as a construction element in, on or outside a building or a civil engineering structure.

Regarding the advantages to be achieved therewith, reference is made to the respective explanations on the apparatus in order to avoid repetitions. The features described in connection with the apparatus can be used for further configuration.

The civil engineering structure can e.g. be, but is not limited to, a bridge, a horizontal wind turbine or a vertical wind turbine or other civil engineering structures.

The invention also achieves the above-mentioned object by usage of at least one apparatus according to one or more of the above aspects on or in the facade of a new building and/or of an existing building as additive element on a conventional existing facade.

Regarding the advantages to be achieved therewith, reference is made to the respective explanations on the apparatus in order to avoid repetitions. The features described in connection with the apparatus can be used for further configuration.

Not only new buildings can be equipped with this apparatus, but also existing buildings with conventional facades of frame and solid constructions (such as concrete, brick and/or wooden facades, thermal insulation composite systems, etc.). By retrofitting, these buildings become more ecological, e.g. by saving water, reducing the building's internal energy consumption (e.g. for building interior conditioning and water pump energy) and/or by offering the possibility of energy efficient urban cooling whilst reducing the impact on the public sewing infrastructure as well.

A conventional thermal insulation composite system can e.g. have the following structure (from outside to inside): External plaster, thermal insulation, masonry and internal plaster. The device can in this case be installed on the outside O of the external plaster and statically fixed in the load-bearing masonry by the holding device.

The invention also achieves the above-mentioned object by a facade system for separating a building interior (inside) I from an exterior space (outside) O, having an apparatus according to one or more of the above aspects, the facade system optionally being constructed in one or more layers and/or modularly. Thus, a hydroactive facade can be provided.

Regarding the advantages to be achieved therewith, reference is made to the respective explanations on the apparatus in order to avoid repetitions. The features described in connection with the apparatus and/or the features described in the following can be used for further configuration of the multi-layer facade system.

In an advantageous way, on the side on which the second textile layer of the textile element (apparatus) is located, the facade system can have at least one fluid-flow-through layer and/or an insulation layer for thermal and/or acoustic damping purposes and/or an inner layer e.g. an (acoustic) textile and/or a PVC coated polyester membrane or a PTFE coated glass fibre fabric or the like. Functional layers (e.g. fluid-flow-through layers) can be used to regulate the building interior climate (temperature control of the building interior wall surfaces and/or regulation of the interior air humidity) and/or for regulation of the acoustic and sound insulation properties and/or for active fire protection measures. Besides, the fluid-flow-through layer can serve as a water storage for precipitation water.

In an appropriate manner, two fluid-flow-through layers can be provided, wherein the first fluid-flow-through layer is arranged on one side of the insulation layer and the second fluid-flow-through layer is arranged on the other side of the insulation layer. More water can be stored by two fluid-flow-through layers. In addition, solar heat energy can be absorbed or discharged on both sides of the thermal insulation layer. This contributes to a flexible, energy efficient application of the facade system.

In an advantageous way, one of the two or both fluid-flow-through layers can be configured and utilized as a thermal collector and/or can be used for temperature control of the building interior wall surfaces and/or for regulation of the interior air humidity and/or for regulation of the acoustic and sound insulation properties and/or for active fire protection measures. When used as a thermal collector, solar radiation is absorbed and converted into heat. When used as a heating unit one of the two or both of the fluid-flow-through layers can emit heat energy on the corresponding side of the insulation layer depending on the prevailing ambient conditions and the need for conditioning. In addition, heat flux and/or interior comfort in terms of temperature, humidity and/or acoustics can be influenced. For this purpose, selective water flow of precipitation water and/or of water from the public water supply network can be initiated through these layers.

In an appropriate manner, a further apparatus according to one or more of the above aspects can be provided, said further apparatus forming the inner layer, wherein the first layer of the textile element of the further apparatus faces the building interior (inside) I. Consequently, a further functional layer for regulating interior temperature and air humidity is provided with a further textile element acting as an evaporator on the inside I. With the first layer facing the building interior this further apparatus is arranged “laterally reversed” in comparison to the first apparatus.

In an advantageous way, the facade system can comprise a preferably modular profile system to which the components of the multi-layer facade system and/or the holding device of the apparatus as described above are attached or attachable. Thus, the facade system can be modularly upgraded with additional layers and adapted to the application as well as to the specific local conditions and building requirements. For example, in cold regions an additional insulating layer can be added by extending the profile system with another profile module. Preferably, the frame profile and the holding device of the apparatus are mutually compatible. Thus, the frame profile can be integrated, connected and/or attached to the holding device. The profile system can be made from aluminium, steel, polymer or wood or the like or combinations thereof (aluminium, steel, polymer, wood or combined profile system).

The invention also achieves the above-mentioned object by a method for operating an apparatus according to one or more of the above aspects and/or a multi-layer facade system according to one or more of the above aspects, wherein precipitation water (absorbed by the apparatus described above) is supplied to a use in, on or outside the building and/or wherein water (provided by the public water supply network) and/or precipitation water (absorbed by the apparatus described above) is supplied to the apparatus e.g. to the textile element to be discharged by evaporation.

Regarding the advantages to be achieved therewith, reference is made to the respective explanations on the apparatus in order to avoid repetitions. The features described in connection with the apparatus, the multi-layer facade system and/or the features described in the following can be used for further configuration of the apparatus and/or of the multi-layer facade system.

In an appropriate manner, water (provided by the public water supply network) and/or precipitation water (absorbed by the apparatus described above) can be discharged via the textile element, in particular by evaporation. Thus, evaporative cooling of the facade, the air space close to the facade and/or the urban space can be realized, e.g. in case of heat stress caused by absorption of solar radiation on facades and/or other sealed urban surfaces.

In an advantageous way, precipitation water absorbed by the apparatus can be supplied to consumer in, on or outside the building in the form of raw water and/or can be processed into drinking water. Thus, reduced demand of drinking water (e.g. provided by public water supply network) as well as reduced demand of water pumping energy can be achieved (i.e. water does not need to be pumped from public water supply network to a user on any floor in a high-rise building).

In an appropriate manner, the precipitation water can be used for the interior conditioning of buildings. Thus, interior and user comfort can be increased, e.g. by temperature control of wall surfaces (heating and/or cooling), regulation of room air humidity, etc. as well as by regulating the acoustic and sound insulation properties or qualities of the facade system.

In an advantageous way, the precipitation water can be provided for plant-specific fire protection measures. Thus active fire protection measures can be implemented in, on or outside a building.

In an appropriate manner, the precipitation water can be discharged to the public water supply network and/or delivered to neighbouring buildings and/or civil engineering structures, especially in the case of excess precipitation water yields. Thus, additional buildings and/or civil engineering structures can be supplied with precipitation (raw) water and/or with processed drinking water.

The invention also achieves the above-mentioned object by a method e.g. a software for controlling and/or regulating an apparatus for absorbing and discharging (precipitation) water, in particular an apparatus according to one or more of the above aspects and/or a multi-layer facade system according to one or more of the above aspects. The method comprises the following steps:
retrieving forecast weather data from a weather service (e.g. via the Internet) for a defined (past, present or future) time period,
estimating the water consumption of drinking water, raw water and/or grey water in, on or outside a building or civil engineering structure in the defined time period, e.g. by means of analysis of the water consumption in, on or outside the building or civil engineering structure (e.g. by means of a flow meter), and
comparing the estimated consumption of drinking and/or raw water and/or grey water with expected precipitation water yields from the forecast weather data.

Regarding the advantages to be achieved therewith, reference is made to the respective explanations on the apparatus in order to avoid repetitions. The features described in connection with the apparatus, the multi-layer facade system and/or the features described in the following can be used for further configuration of the apparatus and/or of the multi-layer facade system.

In an advantageous way, the amount of water required for evaporative cooling of the facade, the air space close to the facade and/or the urban space can be determined, e.g. in case of heat. This makes it possible to determine how much water is needed for this purpose and how much water can be supplied for other purposes or to consumer.

In an appropriate manner, the amount of drinking water, raw water and/or grey water consumption required for consumer in, on or outside the building or civil engineering structure can be determined. Thus, raw water can be provided to consumer, e.g. for plant watering, washing machine operation and/or toilet flushing. Plant watering includes the watering of private as well as public green spaces, e.g. by attaching the apparatus to public buildings and/or public civil engineering structures.

In an advantageous way, the amount of water required for interior conditioning of the building or civil engineering structure can be determined. Thus, the determination of requirements also refers to the consumption related to indoor comfort. Interior conditioning can be done by regulation of interior wall surface temperatures and/or room air humidity and/or by acoustic and sound control of the interior.

In an appropriate manner, the amount of water required for the use of plant-specific fire protection measures can be determined. Thus, the determination of requirements also considers active fire protection measures.

In an advantageous way, excess water absorbed by the apparatus above can be delivered to neighbouring buildings and/or civil engineering structures and/or excess water can be fed into the public water supply network. Thus, if one or more determination of requirements (water requirement for evaporative cooling, water requirement for consumer, water requirement for interior conditioning and/or water requirement for plant-specific fire protection measures) show that excess water is available, it can be supplied to the public water supply network and/or to other buildings or civil engineering structures and/or to other customer. This contributes to an intelligent, economic and ecologic water supply in urban areas.

The invention is described in more detail below with reference to the figures. Identical or functionally identical elements are designated with same reference signs, but possibly only once. The figures show:

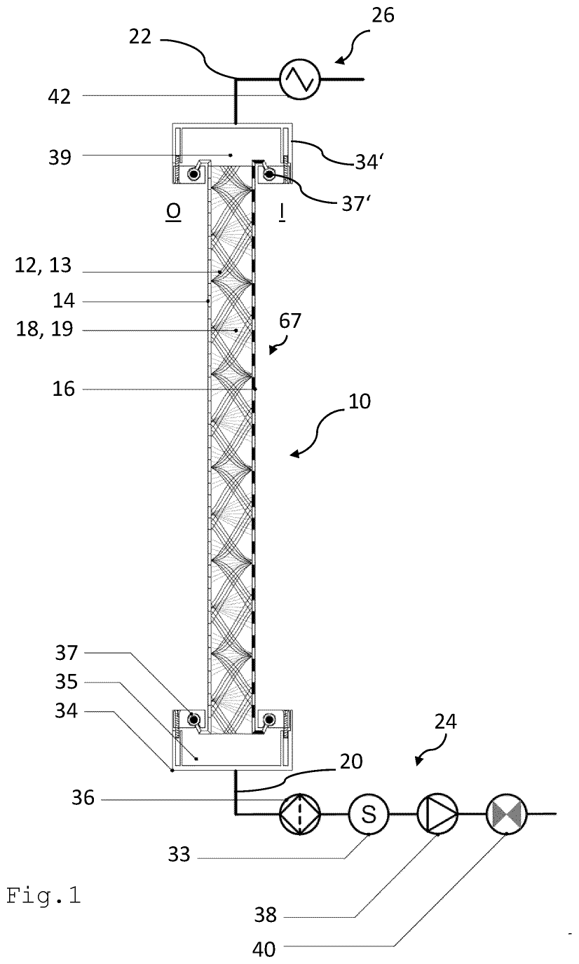

FIG. 1 an embodiment of an apparatus for absorbing precipitation water and for discharging water by evaporation;

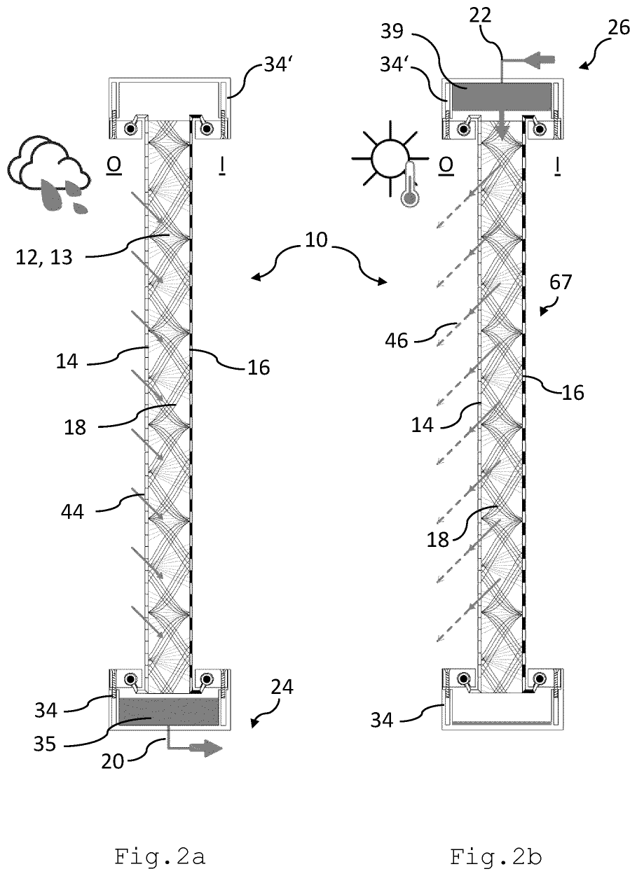

FIG. 2a,b operation of the apparatus of FIG. 1 in case of rain to absorb precipitation water (FIG. 2a) and in case of high outdoor temperatures to discharge water by evaporation (FIG. 2b);

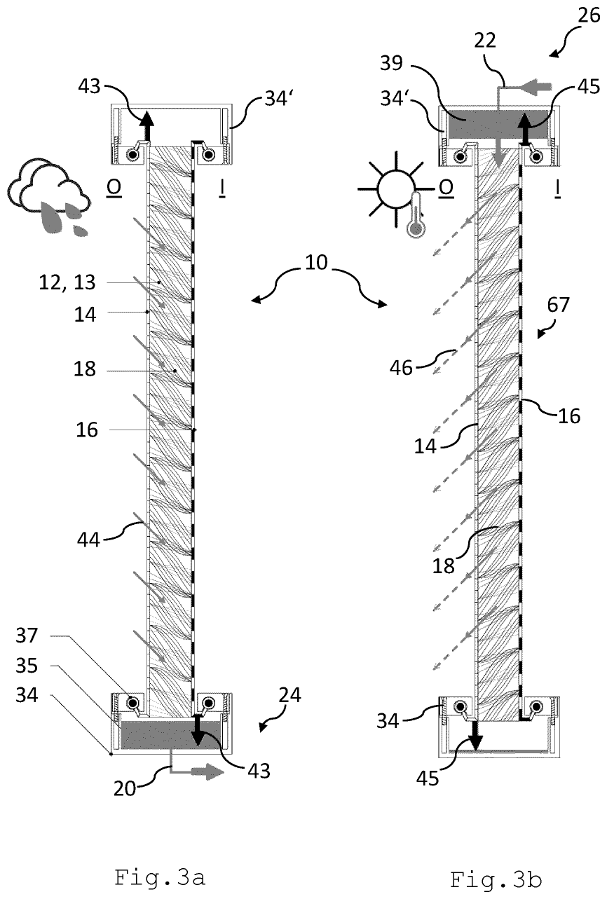

FIG. 3a,b operation of the apparatus of FIG. 1 when provided with actuators for actuating the first layer and/or the second layer of the textile element in case of rain to absorb precipitation water (FIG. 3a) and in case of high outdoor temperatures to discharge water by evaporation (FIG. 3b);

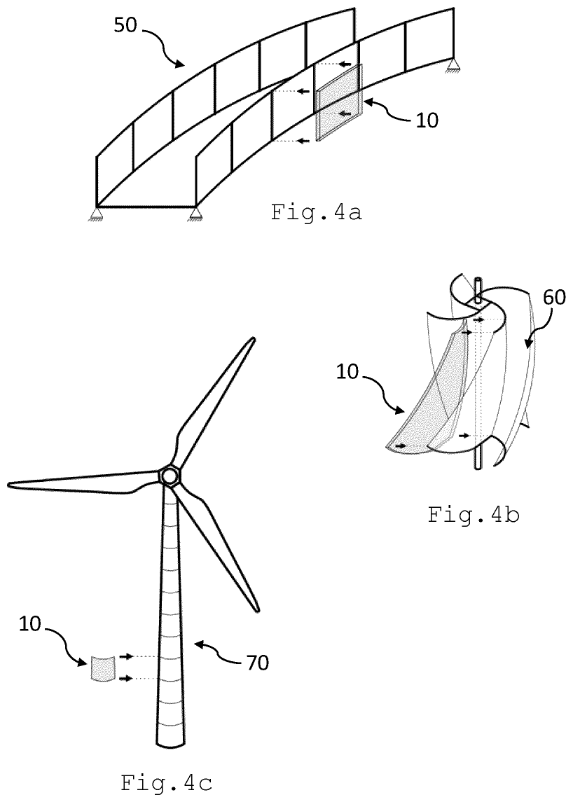

FIG. 4a-c usage of the apparatus according to FIG. 1 as a construction element at a bridge (FIG. 4a), at a vertical wind turbine (FIG. 4b) or at a horizontal wind turbine (FIG. 4c);

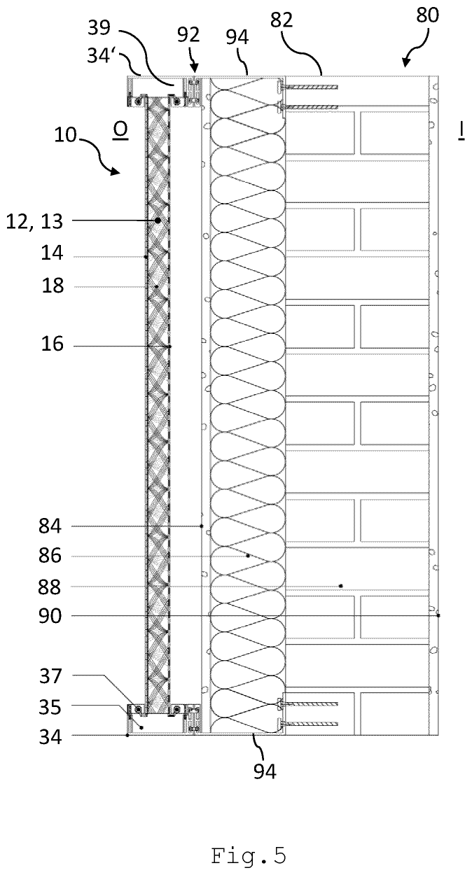

FIG. 5 usage of the apparatus according to FIG. 1 on a conventional facade (e.g. thermal insulation composite system) of an existing building;

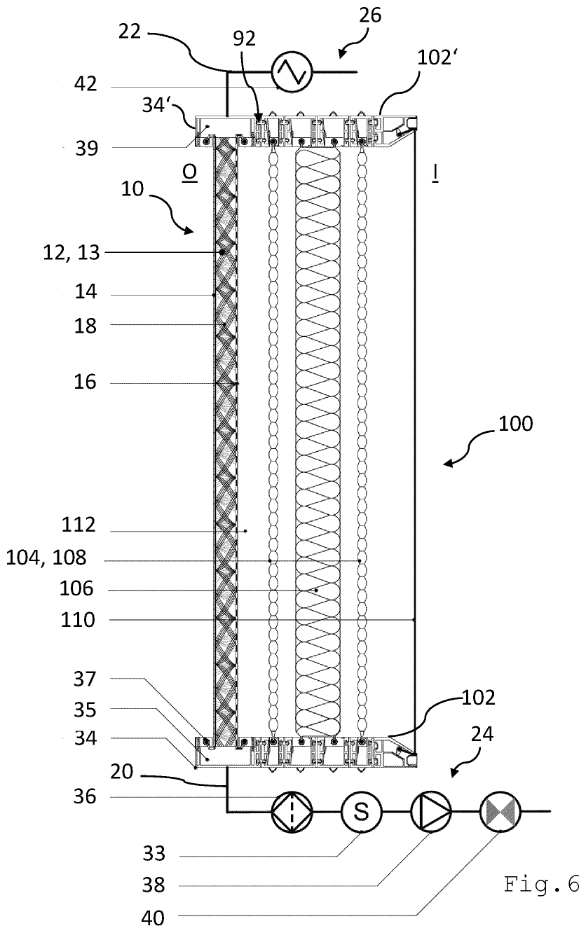

FIG. 6 an embodiment of a multi-layer facade system with the apparatus according to FIG. 1 being integrated therein;

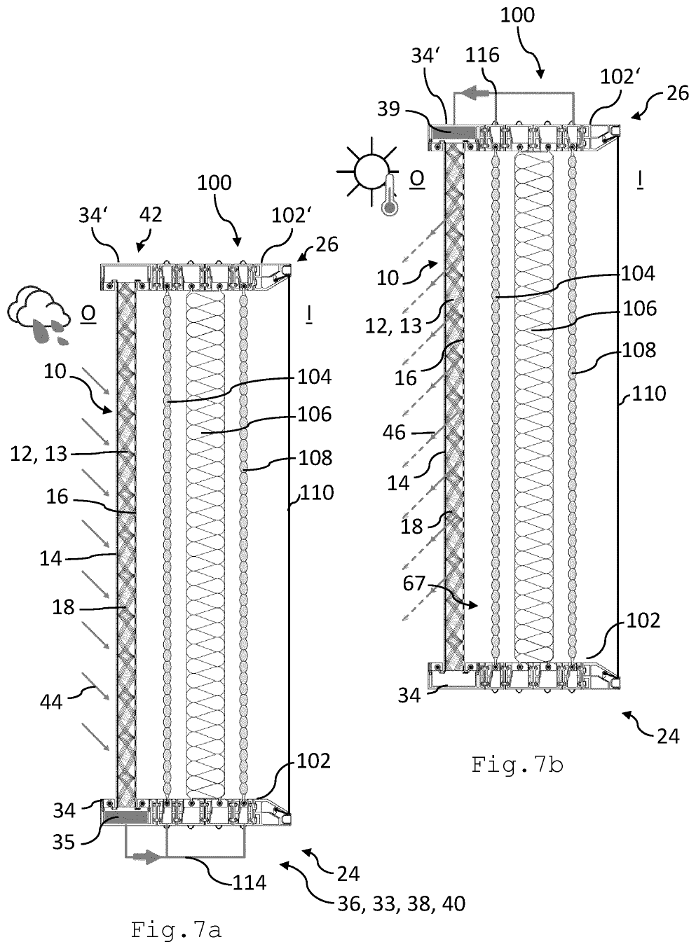

FIG. 7a,b operation of the multi-layer facade system of FIG. 6 in case of rain to absorb precipitation water (FIG. 7a) and in case of high outdoor temperatures to discharge water by evaporation (FIG. 7b);

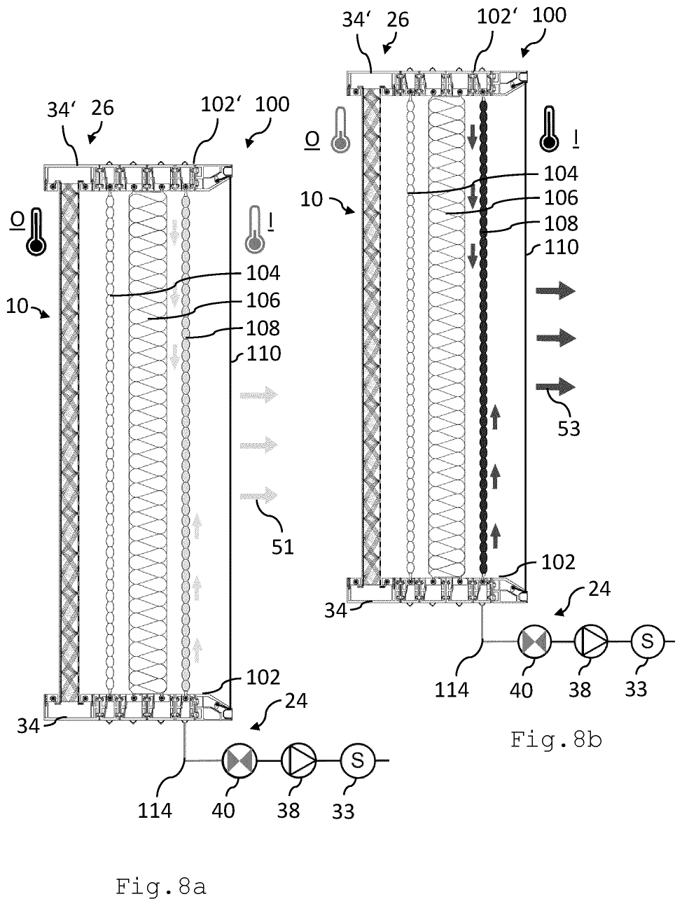

FIG. 8a,b the multi-layer facade system of FIG. 6 with temperature control of individual layers for regulation of interior wall surface temperatures in hot weather conditions (FIG. 8a) and in cold weather conditions (FIG. 8b);

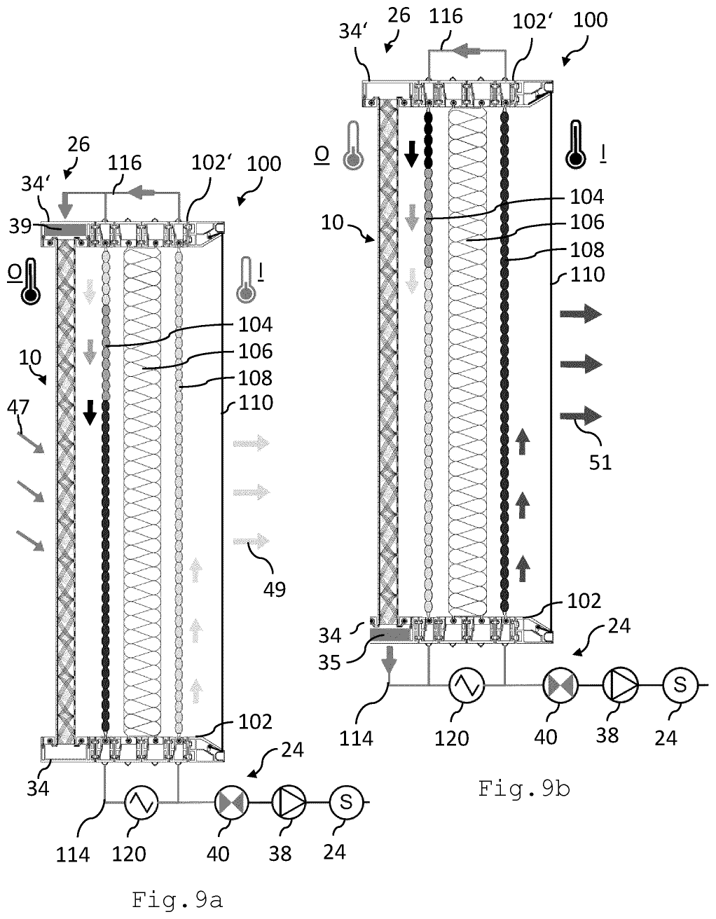

FIG. 9a,b the multi-layer facade system of FIG. 6 when being used as a thermal collector (FIG. 9a) and/or for influencing the heat flux of the facade to the outside O (FIG. 9b);

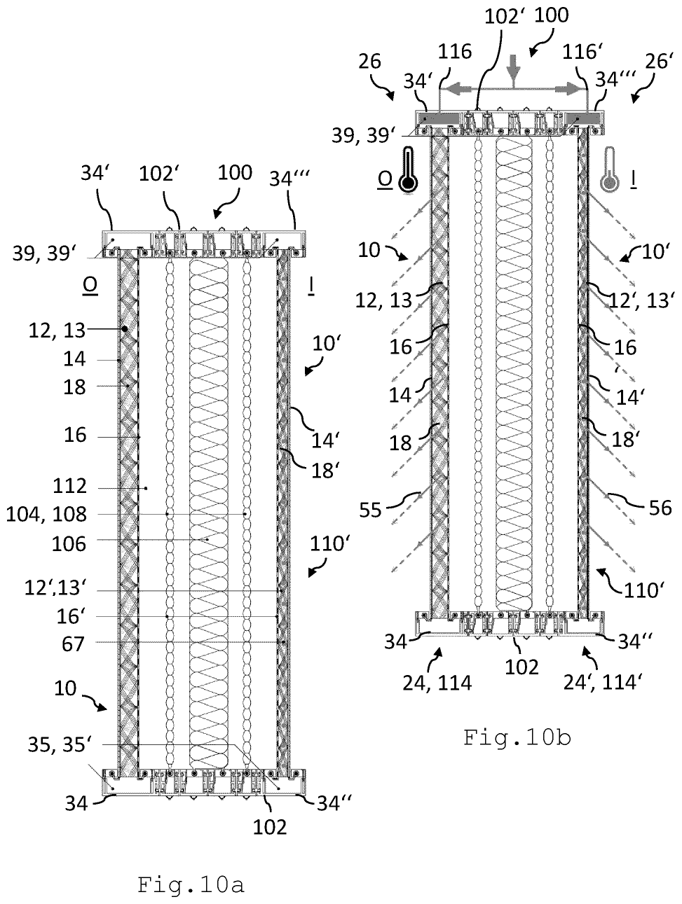

FIG. 10a,b the multi-layer facade system of FIG. 6 having a further apparatus according to FIG. 1 forming an inner layer of the facade system (FIG. 10a) and the operation of the multi-layer facade system with a further apparatus when discharging water by evaporation for the interior (FIG. 10b); and

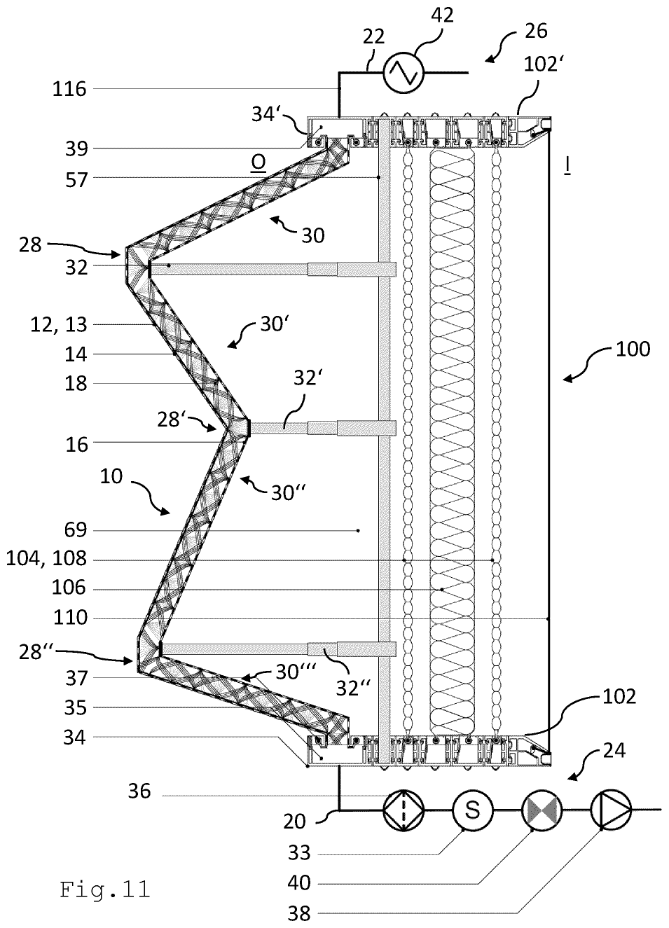

FIG. 11 the multi-layer facade system of FIG. 6 when the apparatus according to FIG. 1 is being provided with folding structures and actuators for operating the folding structures.

FIG. 1 shows an apparatus 10 for absorbing precipitation water from rain events, especially from driving rain events, and for water discharge by evaporation. The apparatus 10 comprises a textile element 12 for absorbing rainwater drops and/or for discharging water (provided by the public water supply network) and/or precipitation water (absorbed by the apparatus described above) by evaporation. The textile element 12 embodies a three-dimensional textile structure 13, with a first, water-permeable layer 14 (outer layer 14) and a second, water-guiding layer 16 (inner layer 16). The first layer 14 and the second layer 16 are connected to one another by means of water-guiding connecting threads 18. The connecting threads 18 form a spacing structure 19. In the embodiment shown, the textile element 12 is fluidically connected to a water discharge conduit 20 and to a water supply conduit 22.

The water discharge conduit 20 is flow-connected downstream to the textile element 12. The water supply conduit 22 is flow-connected upstream to the textile element 12.

A water collecting device 24 is provided which is flow-connected to the textile element 12 and/or to the water discharge conduit 20. The water collecting device 24 can comprise different components for storing, treating (e.g. filtering) and/or transporting water.

A water supply device 26 is provided which is flow-connected to the textile element 12 and/or to the water supply conduit 22. The water supply device 26 can be flow-connected to the public water supply network or to the water collecting device 24 (not shown).

The textile element 12 i.e. the three-dimensional textile structure 13 can preferably be formed from synthetic and/or polymer fibre (e.g. polyethylene (PE) fibre, polyester (PES/PET) fibre, polypropylene (PP) fibre, polyamide (PA) fibre, polytetrafluorethylene (PTFE) fibre, ethylene tetrafluoroethylene (ETFE) fibre or the like), from glass fibre, metal fibre and/or other materials, wherein these materials are embodied as monofilaments or multifilaments, wherein the filaments may be optimized in shape, e.g. spiral shape for better water transport.

The apparatus 10 and/or the textile element 12 can comprise hydrophilic (water attracting) and/or hydrophobic (water-guiding, water-repellent) modifications (not shown). The hydrophilic and/or hydrophobic modifications can be embodied as laminations, coatings, finishings, filament shape optimizations (e.g. spiral shaped filament) and/or additive surface structures that are microstructured or macrostructured, as explained above. Modification materials can for example be polytetrafluorethylene (PTFE), polyvinyl chloride (PVC), silicone, paraffin wax and/or nanocoatings like titanium dioxide (TiO₂) and/or silicon dioxide (SiO₂) or the like or combinations thereof.

The first layer 14 of the textile element 12 may have a water-attracting and/or hydrophilic lamination, coating, finishing, filament shape optimization and/or a (separate) water-attracting layer that is additively applied to the first layer 14 (not shown). The (separate) layer and/or the first layer 14 can be of finer-pored design than the spacing structure 19 formed by the connecting threads 18 between the first layer 14 and the second layer 16 of the textile element 12. The finer-pored textile may comprise e.g. a multifilament or nonwoven fabric to encapsulate more water, thus leading to more effective and economical evaporative cooling effect (not shown).

The second layer 16 of the textile element 12 may have a water-guiding (water-repellent) and/or hydrophobic lamination, coating, finishing, filament shape optimization and/or a (separate) water-guiding (water-repellent) and/or hydrophobic layer is additively applied to the second layer 16 (not shown). The (separate) layer and/or the second layer can be water-tight or perforated. The (separate) water-guiding (water-repellent) and/or hydrophobic layer can be embodied by laminating a foil (e.g. polyethylene (PE) foil, polyester (PES/PET) foil, polyvinyl chloride (PVC) foil, polytetrafluorethylene (PTFE) foil, ethylene tetrafluoroethylene (ETFE) foil, polypropylene (PP) foil, polyamide (PA) foil, silicone foil, latex foil, metal foil or similar) and/or a plate (metal plate, glass plate, silicone plate, polymer plate or similar) or the like onto the second layer 16.

To improve evaporation behaviour, an additional, finer-pored textile layer for encapsulating more water, e.g. a multifilament and/or nonwoven fabric and/or a superabsorber or the like (not shown), can be applied between the second layer 16 of the textile element 12 and the (separate) applied water-guiding (water-repellent) layer (not shown) to the exterior space (outside) O of the apparatus, thus contributing to more homogeneous wetting and higher evaporative cooling while reducing water consumption.

In present embodiment, the apparatus 10 and the textile element 12 are planar in shape. In other embodiments, the apparatus 10 and/or the textile element 12 can be curved (e.g. anticlastic, synclastic, concave or convex), folded and/or adaptable in shape (see FIGS. 4a,b,c and 11).

The first layer 14 and/or the second layer 16 can be configured as being actuatable by one or more actuators (not shown) provided along a direction parallel to the plane of first layer 14 or second layer 16, respectively (see FIGS. 3a,b).

The apparatus 10 and/or the textile element 12 can comprise folding structures 28, 28′, 28″ that divide the apparatus 10 and/or the textile element 12 into several foldable, folded, pivotable and/or rotatable sections 30, 30′, 30″ (see FIG. 11). The folding structures 28, 28′, 28″ can have a mechanical substructure e.g. of steel, wood, aluminium and/or polymer or the like or combinations thereof and/or the folding structures can be introduced into the textile element 12 by means of additive and/or subtractive manufacturing methods e.g. textile (3D) printing and/or the folding structures 28, 28′, 28″ can be embodied by textile connecting devices e.g. sewing and/or thermal fixation or the like or combinations thereof (not shown).

Actuators 32, 32′, 32″ (e.g. linear and/or rotational actuators) can be provided, by means of which the foldable, folded, pivotable and/or rotatable sections 30, 30′, 30″ can be operated.

Sensors can be provided (not shown), by means of which climate and/or environmental data can be recorded, as explained above.

A control unit (not shown) for operating and/or regulating the actuators 32, 32′, 32″ can be provided, wherein the control unit is configured in such a way that the apparatus 10 and/or the textile element 12 and/or sections 30, 30′, 30″ thereof are adjusted in regard to climate and/or environmental conditions (e.g. to the angle of impact of precipitation water drops and/or to the solar incidence angle). The control unit can be configured to interact with one or several sensors collecting environmental and/or climate data and with actuators that actuate the first layer and/or the second layer of the textile element and/or with actuators that operate the foldable, folded, pivotable and/or rotatable sections of the apparatus and/or of the textile element.

A holding device can be provided to which the components of the apparatus 10 are attached (not shown) or attachable. Thus, the components of the apparatus 10 are arranged relatively to each other and the apparatus 10 can be attached to a building or a civil engineering structure.

The water collecting device 24 can comprise a frame profile 34 in which water collection or water drainage (water outflow) 35 takes place and/or the water collecting device 24 can comprise a water storage 33, which can be embodied as a water storage tank or as a fluid-flow-through layer in a multi-layer facade system (see FIGS. 1 and 6). The textile element 12 can be held linearly by the frame profile 34, e.g. by welt edge (piping) connections 37 and/or punctually and/or by other appropriate fixations (not shown). The frame profile 34 can be integrated, connected and/or attached to the holding device (not shown). Furthermore, the water storage 33 may be flow-connected with the frame profile 34.

A filter 36 for filtering precipitation water is provided, wherein the filter 36 is integrated into the textile element 12 and/or arranged in or on the water collecting device 24, e.g. in or on the frame profile 34 of the water collecting device 24 and/or in the building.

A pump 38 and/or a water temperature control device (water heating and cooling) 40 are provided, which are each flow-connected with the water collecting device 24 via the water discharge conduit 20 and/or with the water supply device 26 via the water supply conduit 22 in the present embodiment.

The water supply device 26 comprises a frame profile 34′, in which water supply 39 takes place. The textile element 12 can be held linearly by the frame profile 34′, e.g. by welt edge (piping) connections 37′ and/or punctually and/or by other appropriate fixations (not shown). The frame profile 34′ can be integrated, connected and/or attached to the holding device. Furthermore, the water storage 33 and/or the public water supply network may be flow-connected with the frame profile 34′.

The water supply device 26 and/or the water collecting device 24 can be connected to a heat exchanger 42, 120.

In an advantageous way, in addition or alternatively to water supply device 26 a further water supply device 67 e.g. comprising one or several linear or punctual injectors can be provided for a homogenous water wetting of the textile element 12.

FIGS. 2a and 2b show the operation of the apparatus 10 according to FIG. 1. On the side facing the first, water-permeable layer 14 (outer layer 14) of the textile element 12 of apparatus 10 is the exterior (outside) O and on the side facing the second, water-guiding layer 16 (inner layer 16) of the textile element 12 of apparatus 10 is the interior (inside) I.

FIG. 2a shows the apparatus 10 during rain or driving rain events when absorbing precipitation water. In this situation, the apparatus 10 acts as an absorber and collector device. Precipitation water can be absorbed (collected) by the apparatus 10 e.g. by the textile element 12 and optionally stored. When absorbing, precipitation water enters the textile element 12 on the side of the first layer 14 (see arrows 44). The precipitation water is led from the first, water-permeable layer 14 along the connecting threads 18 to the second, water-guiding layer 16.

Since the second layer 16 is water-guiding (water-repellent) and/or hydrophobic, absorbed precipitation water does not or only in a negligible way infiltrate into or beyond the second layer 16 or into the interior of a multi-layer facade system. Under the influence of gravity, absorbed water flows downwards in the textile element 12, along the second layer 16 to water collection or water drainage (water outflow) 35 e.g. to a reservoir, basin, gutter, or the like that may be integrated in the (lower) frame profile 34 of the water collecting device 24. From there, absorbed and collected water can be fed to a water storage, a water consumer and/or to the public water supply network, for example.

FIG. 2b shows the apparatus 10 during heat events when discharging water by evaporation. In this situation, the apparatus 10 acts as an evaporator device. Water can be evaporated by the apparatus 10 e.g. by the textile element 12 for evaporative cooling of the exterior e.g. of the building facade (multi-layer facade system 100 or conventional facade 82 of an existing building 80) and/or of the air volume close to the facade and/or of the urban space and/or for evaporative cooling of a building's interior (see FIG. 10a,b). For evaporating, water enters the textile element 12 from the water supply 39 e.g. from the frame profile 34′ of the water supply device 26 arranged upstream of the textile element 12. Under the influence of gravity, the supplied water moves along the second, water-guiding (water-repellent) and/or hydrophobic layer 16 downwards in the textile element 12, moving to the first, water-permeable layer 14 via the connecting threads 18. During this process, the water in and on the apparatus 10 e.g. in and on the textile element 12 evaporates due to solar radiation and heat prevailing on the outside O of the apparatus 10 (see arrows 46). The evaporation process causes corresponding cooling energy to be released which reduces the effect of heat loads on the outside O of the apparatus 10 and/or of the multi-layer facade system 100.

For homogeneous water wetting of the evaporator surface, alternatively or in addition to water supply device 26 an (additional) water supply device 67 can be provided to supply the textile element 12 punctually or linearly preferably at several places and/or at different heights with water. The water supply device 67 may comprise one or several injectors e.g. water jets, (perforated) pipes or hoses arranged side by side along the height and/or the width of the apparatus 10 e.g. of the textile element 12 (not shown). Preferably the water supply device 67 can be flow-connected with the water supply device 26 e.g. the frame profile 34′ and/or with the water supply conduit 22 and/or with the water collecting device 24 e.g. the frame profile 34 and/or with the water discharge conduit 20.

The water supplied to the textile element 12 via water supply device 26 and/or via water supply device 67 may be water that has previously been absorbed (collected) and stored by the apparatus 10 and/or water that has been provided by public water supply network.

FIGS. 3a and 3b show the operation of the apparatus 10 when provided with actuators (not shown) for actuating the first layer 14 and/or the second layer 16 of the textile element 12.

As mentioned above, the first layer 14 and/or the second layer 16 can be configured as being actuatable by one or more actuators (not shown) provided along a direction parallel to the plane of first layer 14 or second layer 16, respectively. Thus, the first layer 14 and the second layer 16 can be displaced relatively to one another. In this manner, the orientation e.g. the inclination angle of the connecting threads 18 can be changed.

FIG. 3a shows a situation, in which the first layer 14 is actuated to be displaced against the direction of gravity (upwards) and/or in which the second layer 16 is actuated to be displaced along the direction of gravity (downwards; see arrows 43). This aligns the connecting threads 18 so that they are inclined downwards from the first layer 14 to the second layer 16. In this way, water absorption behaviour is improved (see arrows 44), as absorbed water moves faster from the first layer 14 to the second layer 16 and thus moves faster downwards in the textile element 12 to water collection or water drainage (water outflow) 35 e.g. to a reservoir, basin, gutter, or the like that may be integrated into the (lower) frame profile 34 of the water collecting device 24.

FIG. 3b shows a situation, in which the first layer 14 is actuated to be displaced along the direction of gravity (downwards) and/or in which the second layer 16 is actuated to be displaced against the direction of gravity (upwards; see arrows 45). This aligns the connecting threads 18 so that they are inclined upwards from the first layer 14 to the second layer 16. In this way, water discharging behaviour is improved (see arrows 46), as water provided to the textile element 12 by the water supply 39 of water supply device 26 and/or of water supply device 67 moves downwards faster and thus moves also faster to the first, water-permeable layer 14.

FIGS. 4a to 4c show the usage of the apparatus 10 according to FIG. 1 as a construction element to different buildings or civil engineering structures.

FIG. 4a shows an application of the apparatus 10 to a civil engineering structure in the form of a bridge 50. The apparatus 10 and/or the textile element 12 are planar in shape (planar collector and/or evaporator surface). In this application, the apparatus 10 and/or the textile element 12 as well can be curved (e.g. anticlastic, synclastic, concave or convex), folded and/or adaptable in shape (not shown).

FIG. 4b shows an application of the apparatus 10 to a civil engineering structure in the form of a wind turbine 60. The apparatus 10 and/or the textile element 12 are synclastically (double) curved in shape (synclastically curved collector and/or evaporator surface). In this application, the apparatus 10 and/or the textile element 12 can be (double) curved anticlastically (anticlastically curved collector and/or evaporator surface) as well (not shown).

FIG. 4c shows an application of the apparatus 10 to a civil engineering structure in the form of a wind turbine 70. The apparatus 10 and/or the textile element 12 are convex (simply) curved in shape (convex curved collector and/or evaporator surface). In this application, the apparatus 10 and/or the textile element 12 can be (simply) curved concave (concave curved collector and/or evaporator surface) as well (not shown).

FIG. 5 shows the usage of the apparatus 10 according to FIG. 1 on a conventional facade 82 (e.g. on a thermal insulation composite system) of an existing building 80.

The existing building 80 is equipped with the apparatus 10 by mounting the apparatus to the supporting components of the building facade e.g. to the masonry in the case of solid constructions 88 or to the steel structure in the case of frame constructions (not shown). A conventional facade 82 (e.g. thermal insulation composite system) may have the following components (from outside to inside): External plaster 84, thermal insulation 86, supporting components of the building facade e.g. masonry in the case of solid constructions 88 and internal plaster 90.

The apparatus 10 is mounted to a conventional facade 82 (e.g. to a thermal insulation composite system) of an existing building 80 by a holding device 92. The holding device 92 comprises mounting brackets 94 that are connected to the frame profile 34, 34′ of the apparatus 10 on one end and to the facade 82, in other words to the supporting components of the building facade e.g. masonry in the case of solid constructions 88 or to the steel structure in the case of frame constructions (not shown), on the other end, for example by screws.

By retrofitting an existing building 80 with the apparatus the building becomes more ecological, e.g. through lower energy consumption and water savings by offering urban climate advantages at the same time.

FIG. 6 shows an embodiment of a multi-layer facade system 100 for separating a building interior (inside) I from an exterior space (outside) O. The facade system 100 comprises an apparatus 10 that is integrated on the side facing the exterior (outside) O of the multi-layer facade system 100. The apparatus 10 corresponds to the apparatus 10 in FIG. 1, reference being made to the specifications in FIG. 1 to avoid repetition.

The facade system 100 represents a hydroactive facade, that allows to absorb water from rain events by the apparatus 10, to store and/or to use water absorbed by the apparatus 10 and/or water supplied by the public water supply network e.g. for interior conditioning in several layers of the facade system 100 and/or to discharge water for evaporative cooling by the apparatus 10.

The facade system 100 can be constructed in one or more layers and/or modularly. The facade system 100 comprises a preferably modular profile system 102, 102′ to which the components of the multi-layer facade system 100 and/or the holding device 92 and/or the frame profile 34, 34′ of the apparatus 10 can be attached. The frame profile 34, 34′ of the apparatus 10 and/or the holding device 92 and the profile system 102, 102′ are compatible with each other. In this embodiment, the frame profile 34, 34′ of apparatus 10 is attached to the profile system 102, 102′of the facade system 100. The profile system 102, 102′ can be embodied as an aluminium, steel, polymer or wood profile system or the like or combinations thereof.

The modular profile system 102, 102′ holds several layers of the facade system 100. In this embodiment, the multi-layer facade system 100 comprises on the side on which the second layer 16 of the textile element 12 of the apparatus 10 is located, (from outside to inside) a first fluid-flow-through layer 104, an insulation layer 106, a second fluid-flow-through layer 108 and an inner layer 110, e.g. an (acoustic) textile and/or an inner membrane. These layers are separated from each other by air spaces (air layers), for example by air space (air layer) 112 between the textile element 12 of apparatus 10 and the first fluid-flow-through layer 104.

Via insulation layer 106, fluid-flow-through layers 104, 108 and inner layer 110 the thermal and acoustic properties of the facade system 100 as well as building interior comfort are optimized. Fluid-flow-through layers 104, 108 can serve as a reservoir for storage of precipitation water and/or for climate and acoustic regulation of the interior and/or for active fire protection measures. Fluid-flow-through layers 104, 108 are flow-connected with the apparatus 10 e.g. with the textile element 12, particularly with the water collecting device 24 and/or with the water supply device 26 e.g. via the profile system 102, 102′, via the frame profile 34, 34′, via the water discharge conduit 20, via the water supply conduit 22 and/or via fluid connections 114, 116.

FIGS. 7a and 7b show the operation of the multi-layer facade system 100 according to FIG. 6.

FIG. 7a shows the multi-layer facade system 100 during rain or driving rain events when the apparatus 10 is absorbing precipitation water. When absorbing, precipitation water enters the textile element 12 of the apparatus 10 on the side of the first, water-permeable layer 14 (see arrows 44). Under the influence of gravity, absorbed precipitation water moves from the first, water-permeable layer 14 via the connecting threads 18 down to the second, water-guiding layer 16 to water collection or water drainage (water outflow) 35 e.g. to a reservoir, basin, gutter, or the like that may be integrated in the (lower) frame profile 34 of the water collecting device 24.

Via fluid connection 114, the absorbed precipitation water is led, e.g. by a pump 38, from the (lower) frame profile 34 to the fluid-flow-through layers 104, 108, where the absorbed precipitation water is stored and/or used for interior comfort purposes. From there, the stored water can be discharged later in time. The fluid connection 114 can be further connected to a filter 36 for filtering precipitation water and/or to a further water storage 33 e.g. to a water storage tank and/or to a pump 38 and/or to a water temperature control device (water heating and cooling) 40 and/or to a heat exchanger 42, 120.

FIG. 7b shows the multi-layer facade system 100 during heat events when discharging water by evaporation. By means of fluid connection 116, water (e.g. water absorbed by the apparatus 10) stored in the fluid-flow-through layers 104, 108 and/or in a further water storage 33 e.g. in a water storage tank and/or water supplied by the public water supply network, is led into the water supply 39 e.g. into a gutter, pipe, tube, inflow line, funnel or the like that may be integrated in the (upper) frame profile 34′ of the water supply device 26 arranged upstream of the textile element 12. From there, under the influence of gravity, the supplied water moves along the second, water-guiding layer 16 downwards in the textile element 12, moving to the first, water-permeable layer 14 via the connecting threads 18. During this process, due to solar radiation and heat prevailing on the outside O of the facade system 100, the water evaporates in and on the apparatus 10 e.g. in and on the textile element 12 (see arrows 46). The phase transition of the water from a liquid to a vapour state releases cooling energy. Thus, the effect of heat loads on the outside O can be reduced.

Alternatively or in addition to water supply 39 of water supply device 26, in order to optimize evaporation behaviour by creating a homogenously wetted evaporator surface, an (additional) water supply device 67 can be provided. This allows water to be supplied to the textile element 12 punctually or linearly preferably at several places and/or at different heights. The water supply device 67 may comprise one or several injectors e.g. water jets, (perforated) pipes or hoses arranged side by side along the height and/or the width of the apparatus 10 e.g. of the textile element 12 (not shown). In another embodiment, the water supply device 67 may be configured as a planar perforated water supply device e.g. the fluid-flow-through layer 104 can be perforated and connected to the apparatus 10 e.g. to the textile element 12 via the second, water-guiding layer 16 in perforated configuration, in such way, that by regulating the pressure inside of the fluid-flow-through layer 104 water is homogenously supplied from the fluid-flow-through layer 104 into the textile element 12. Preferably the water supply device 67 can be flow-connected with the water supply device 26 via the profile system 102′, the frame profile 34′, the water supply conduit 22 and/or via fluid connection 116. Also, the water supply device 67 can be flow-connected with the water collecting device 24 via the profile system 102, the frame profile 34, the water discharge conduit 20 and/or via fluid connection 114.

Water, which moves to the water collection or water drainage (water outflow) 35 and/or to the (lower) frame profile 34 through the textile element 12, can be fed back to the fluid-flow-through layers 104, 108 and/or back to the water supply device 26 and/or to the water supply device 67 via the fluid connection 114.

FIGS. 8a and 8b show another use of the multi-layer facade system 100 according to FIG. 6.

In the representation of the enclosed figures below, the light gray color indicates cool, low temperatures whereas the dark gray color symbolizes warm, high temperatures.

FIG. 8a shows the multi-layer facade system 100 with temperature control of individual fluid-flow-through layers for regulation of interior wall surface temperatures in hot weather conditions, e.g. in summer. In this embodiment, cooled water flows through the second fluid-flow-through layer 108, which is located on the side of the insulation layer 106 facing the interior (inside) I. For this purpose, water that has been absorbed by the apparatus 10 and/or stored in a water storage 33 e.g. in a water storage tank and/or in the first fluid-flow-through layer 104 and/or water supplied by the public water supply network can be cooled by the water temperature control device (water heating and cooling) 40, which is connected to fluid connection 114 and/or to fluid connection 116 and can be fed to the second fluid-flow-through layer 108, e.g. by means of a pump 38. When the water moves along the second fluid-flow-through layer 108, the interior I can be cooled (see arrows 51). This contributes to comfortable indoor climate as well as energy savings in hot weather conditions, e.g. in summer. The cooled water is fed, e.g. by a pump 38, from the fluid connection 114 via the profile system 102 into the second fluid-flow-through layer 108, where it moves upwards to the profile system 102′ or the cooled water is supplied from the fluid connection 116 via the (upper) profile system 102′ into the second fluid-flow-through layer 108, where it moves downwards to the profile system 102.

FIG. 8b shows the multi-layer facade system 100 with temperature control of individual fluid-flow-through layers for regulation of interior wall surface temperatures in cold weather conditions, e.g. in winter. In this embodiment, heated water flows through the second fluid-flow-through layer 108, which is located on the side of the insulation layer 106 facing the interior (inside) I. For this purpose, water that has been absorbed by the apparatus 10 and/or stored in a water storage 33 e.g. in a water storage tank and/or in the first fluid-flow-through layer 104 and/or water supplied by the public water supply network can be heated by the water temperature control device (water heating and cooling) 40, which is connected to fluid connection 114 and/or to fluid connection 116 and can be fed to the second fluid-flow-through layer 108, e.g. by means of a pump 38. When the water moves along the second fluid-flow-through layer 108, heat energy is transferred to the interior I (see arrows 53). This contributes to comfortable indoor climate as well as energy savings in cold weather conditions, e.g. in winter. The heated water is fed, e.g. by a pump 38, from the fluid connection 114 via the profile system 102 into the second fluid-flow-through layer 108, where it moves upwards to the profile system 102′ or the heated water is supplied from the fluid connection 116 via the (upper) profile system 102′ into the second fluid-flow-through layer 108, where it moves downwards to the profile system 102.

FIGS. 9a and 9b show another use of the multi-layer facade system 100 according to FIG. 6.

FIG. 9a shows the multi-layer facade system 100 when being used as a thermal collector. Via the fluid connection 116, water is led to the first fluid-flow-through layer 104 via the (upper) profile system 102′ and/or to the apparatus 10 e.g. to the textile element 12 via water supply device 26 e.g. via the (upper) frame profile 34′ and/or via water supply device 67. From there, the water moves downwards the first fluid-flow-through layer 104 to the (lower) profile system 102 and/or downwards the apparatus 10 e.g. downwards the textile element 12 along the second, water-guiding (water-repellent) layer 16 to the first, water-permeable layer 14 via the connecting threads 18 and/or to the (lower) frame profile 34. By this process the water is warmed by the energy of the solar radiation (see arrows 47). Heat can be extracted from the warmed water by a heat exchanger 42, 120 and/or by the water temperature control device (water heating and cooling) 40 coupled to the fluid connection 114, so that the water can be cooled down. The cooled water is fed, e.g. by a pump 38, via the (lower) profile system 102 into the second fluid-flow-through layer 108, from where it moves upwards and passes through the fluid connection 116 via the (upper) profile system 102′ again to the first fluid-flow-through layer 104 and/or via water supply device 26 e.g. the (upper) frame profile 34′ and/or via water supply device 67 to the apparatus 10 e.g. to the textile element 12. Thus the fluid-flow-through layer 104 on the outside O of the insulation layer 106 absorbs and dissipates heat energy from solar radiation. The fluid-flow-through layer 108 on the inside I of the insulation layer 106 is fed with cool water to reduce the interior temperature (see arrows 49). This contributes to energy savings for interior conditioning as well as to a comfortable indoor climate in hot weather conditions.

The flow direction of the fluid-flow-through layers 104, 108 can also be reversed (not shown). In this case, water is led via the fluid connection 114 to the first fluid-flow-through layer 104 via the (lower) profile system 102. From there, the water is pumped upwards the first fluid-flow-through layer 104 to the (upper) profile system 102′. By this process the water is warmed by the energy of the solar radiation (see arrows 47). Heat can be extracted from the warmed water by a heat exchanger 42, 120 and/or by the water temperature control device (water heating and cooling) 40 coupled to the fluid connection 116, so that the water can be cooled down. The cooled water is fed via the (upper) profile system 102′ into the second fluid-flow-through layer 108, from where it moves downwards and passes through the fluid connection 114 via the (lower) profile system 102 again to the first fluid-flow-through layer 104. Thus the fluid-flow-through layer 104 on the outside O of the insulation layer 106 absorbs and dissipates heat energy from solar radiation. The fluid-flow-through layer 108 on the inside I of the insulation layer 106 is fed with cool water to reduce the interior temperature (see arrows 49). This contributes to energy savings for interior conditioning as well as to a comfortable indoor climate in hot weather conditions.

FIG. 9b shows the multi-layer facade system 100 when being used for temperature control of the fluid-flow-through layers 104, 108 in order to influence the heat flux of the facade to the outside O. Water is heated by the heat exchanger 42, 120 and/or by the water temperature control device (water heating and cooling) 40 coupled to the fluid connection 114 and/or to the fluid connection 116. The heated water is fed, e.g. by a pump 38, from the fluid connection 114 via the profile system 102 and/or from the fluid connection 116 via the profile system 102′ into the second fluid-flow-through layer 108, from where it moves upwards and/or downwards. Thereby, heat energy is transferred to the interior (inside) I (see arrows 51). Either, at the upper part of the profile system 102′, the heated water passes through the fluid connection 116 to the first fluid-flow-through layer 104, from where the heated water moves to the lower part of the profile system 102, e.g. by gravity. Otherwise, the heated water can also be fed through the fluid connection 114 via the (lower) profile system 102 into the first fluid-flow-through layer 104, from where the heated water moves upwards to the (upper) profile system 102′ e.g. by a pump 38. Due to the cold prevailing in the outside O, water is cooled down, as thermal energy contained in the water of the first fluid-flow-through layer 104 is transferred to the environment. By the temperature control of the fluid-flow-through layers 104, 108 the heat flux trough the multi-layer facade system 100 can be reduced. This contributes to energy savings for interior conditioning as well as a comfortable indoor climate during cold weather conditions.

FIGS. 10a and 10b show a possible modification of the multi-layer facade system 100 according to FIG. 6. The facade system 100 largely corresponds to the configuration described in FIG. 6, so that reference is made to the explanations there in order to avoid repetition.

In contrast, the present multi-layer facade system 100 has a further apparatus 10′ corresponding to apparatus 10 according to FIG. 1. The further apparatus 10′ forms an inner layer 110′ of the facade system 100, wherein the first (water-permeable) layer 14′ of the textile element 12′ of the further apparatus 10′ faces the interior (inside) I. Thus, the further apparatus 10′ is in laterally reversed orientation in comparison to the first apparatus 10.

The frame profile 34″ and 34″' of the further apparatus 10′ is connected to the modular profile system 102, 102′ of the facade system 100. The textile element 12′, being designated as or embodying a three-dimensional textile structure 13′ of the further apparatus 10′, is fluidically connected with fluid connection 116′ e.g. via the (upper) frame profile 34″'. Furthermore, the textile element 12′ of the further apparatus 10′ is flow-connected with fluid connection 114′ e.g. via the (lower) frame profile 34″ of the further apparatus 10′.

FIG. 10b shows the multi-layer facade system 100 when discharging water by evaporation, e.g. during hot weather conditions. Via fluid connection(s) 116, 116′, water is supplied to the profile system 102′ and/or to the frame profile(s) 34′, 34″' of the water supply device(s) 26, 26′ arranged upstream of the textile element(s) 12, 12′ and/or via water supply device(s) 67, 67′ directly to the textile element(s) 12, 12′. The water supplied to the textile element(s) 12, 12′ may be water that has been absorbed earlier by the apparatus 10 and/or water provided to the multi-layer facade system 100 by public water supply network.

For evaporating, water enters the textile element(s) 12, 12′ from the frame profile(s) 34′, 34′″. Under the influence of gravity, the supplied water moves downwards along the second, water-guiding (water-repellent) layer(s) 16, 16′ in the textile element(s) 12, 12′ to the first layer(s) 14, 14′ via the connecting threads 18, 18′. During this process the water in and on the apparatus 10, 10′ e.g. in and on the textile element(s) 12, 12′ evaporates due to solar radiation and heat prevailing on the outside O of the apparatus 10 (see arrows 55) and/or due to heat at the inside I of the apparatus 10′ in the interior of a building (see arrows 56). The evaporation process in apparatus 10 and/or in further apparatus 10′ causes corresponding cooling energy to be released, which reduces the effect of heat loads on the outside O and/or on the inside I of the multi-layer facade system 100.

In configuration with a first, water-permeable layer 14′, the water, which is discharged by the further apparatus 10′ facing the interior (inside) I, can be further used to humidify interior air. Otherwise in configuration with a first, water-impermeable layer 14′ and/or a water-impermeable layer that is (additively) applied to the first layer 14′ (not shown) the evaporated water can be retained and drained off inside of the apparatus 10′ e.g. inside of the textile element 12′ in order to avoid and/or to reduce humidification of the interior I. In this embodiment, water and air flow inside of apparatus 10′ causes cooling energy, thus reducing the surface temperature of layer 14′ facing the inside I without releasing humidity to the interior.

In an appropriate manner, in order to improve evaporation behaviour, additional, finer-pored textile layer(s) for encapsulating more water, e.g. multifilament and/or nonwoven fabric(s) and/or superabsorber(s) or the like (not shown), can be applied between the second layer(s) 16, 16′ of the textile element(s) 12, 12′ and the optionally (separate) applied water-guiding (water-repellent) layer(s), thus contributing to more homogeneous wetting and higher evaporative cooling while reducing water consumption.

Optionally, in configuration with a first, water-impermeable layer 14′ of apparatus 10′ facing the interior, an additional, finer-pored textile layer for encapsulating more water, e.g. a multifilament and/or a nonvowen fabric and/or a superabsorber or the like (not shown), as well can be applied between the first layer 14′ of the textile element 12′ and the optionally (separate) applied water-impermeable layer (not shown), thus contributing to more homogeneous wetting and higher evaporative cooling while reducing water consumption.

In an advantageous way, apparatus 10 and apparatus 10′ can be operated simultaneously i.e. mutually together or independently, i.e. separately from each other. When only activating apparatus 10′ for interior cooling and/or interior air humidification, water is supplied via fluid connection 116′ only to water supply device 26′ e.g. to frame profile 34′″ and/or to water supply device 67′ of the textile element 12′. For an equivalent activation of only apparatus 10, reference is made to the explanation of FIG. 7b in order to avoid repetition.

Alternatively or in addition to water supply device(s) 26, 26′ e.g. via the frame profile(s) 34′, 34′″, (additional) water supply device(s) 67, 67′ can be provided. This allows water to be supplied to the textile element(s) 12, 12′ punctually or linearly preferably at several places and/or at different heights. The water supply device(s) 67, 67′ may comprise one or several injectors e.g. water jets, (perforated) pipes or hoses arranged side by side along the height and/or the width of the apparatus 10, 10′ e.g. of the textile element(s) 12, 12′. In another embodiment, the water supply device(s) 67, 67′ may be configured as planar perforated water supply device(s) e.g. the fluid-flow-through layers 104 and/or 108 can be perforated and connected to the apparatus 10, 10′ e.g. to the textile element(s) 12, 12′ via the second, water-guiding layer(s) 16, 16′ in perforated configuration, in such way, that by regulating the pressure inside of the fluid-flow-through layers 104 and/or 108 water is homogenously supplied from the fluid-flow-through layers 104 and/or 108 into the textile element(s) 12, 12′. Preferably the water supply device(s) 67, 67′ can be flow-connected with the water supply device(s) 26, 26′ e.g. with the frame profile(s) 34′, 34′″ via the profile system 102′, via water supply conduit(s) 22, 22′ and/or via fluid connection(s) 116, 116′. Also, the water supply device(s) 67, 67′ can be flow-connected with the water collecting device(s) 24, 24′ e.g. with the frame profile(s) 34, 34″ via the profile system 102, via water discharge conduit(s) 20, 20′ and/or via fluid connection(s) 114, 114′. The evaporation of water can be optimized by homogeneous water wetting of the evaporator surface with regard to the water distribution and quantity by means of the water supply device(s) 67, 67′.

FIG. 11 shows a possible modification of the multi-layer facade system 100 according to FIG. 6. The facade system 100 largely corresponds to the configuration described in FIG. 6, so that reference is made to the explanations there in order to avoid repetition.

In contrast, the present multi-layer facade system 100 comprises an apparatus 10 according to FIG. 1 that has been modified. The textile element 12 comprises folding structures 28, 28′, 28″ that divide the textile element 12 into several foldable, folded, pivotable and/or rotatable sections 30, 30′, 30″, 30′″.

The foldable, folded, pivotable and/or rotatable sections 30′, 30″, 30′″ can be operated by actuators 32, 32′, 32″ e.g. by linear and/or rotational actuators. On one end, the actuators 32, 32′, 32″ are connected to a mechanical substructure 57 e.g. of steel, wood, aluminium and/or polymer or the like or combinations thereof, that is attached to the profile system 102, 102′ and/or to the frame profile 34, 34′ and/or to the holding device 92 of the apparatus 10. On the other end, the actuators 32, 32′, 32″ are connected to the textile element 12 e.g. to the folding structures 28, 28′, 28″ so that sections 30, 30′, 40″, 30′″ can be folded, pivoted and/or rotated when the actuators 32, 32′, 32″ are operated. Between the textile element 12 and the mechanical substructure 57, an air space (air layer) 69 is arranged.

By actuating the folding structures, the collector and/or evaporator surface can be maximized and specifically adjusted, e.g. to the respective angle of the precipitation water drops and/or to the solar incidence angle. In this way, water absorption and drainage behaviour as well as water discharge and evaporation behaviour can be improved. The actuation can be operated in a manual or automatically in an adaptive way by integrating sensors, actuators and a control unit.

As explained above, sensors (not shown) for recording climate and/or environmental data (e.g. ambient temperature, humidity, solar radiation, wind data and/or rain data) and/or a control unit for operating and/or regulating the actuators 32, 32′, 32″ can be provided. The control unit (not shown) can be configured in such a way that the apparatus 10 and/or the textile element 12 and/or sections 30, 30′, 30″, 30′″ thereof are adjusted towards impacting precipitation water and/or towards solar incidence automatically. This helps to maximize the performance of the apparatus.

The control unit (not shown) can be configured to interact with one or several sensors and with actuators 32, 32′, 32″. The operation of the apparatus and/or of the textile element 12 and/or of sections 30, 30′, 30″, 30′″ can be monitored with one or several further sensors. A method e.g. a software is implemented on the control unit for operating the apparatus 10 and/or the multi-layer facade system 100.

Optionally the folding structures can be introduced into the textile element as well by means of additive and/or subtractive manufacturing methods e.g. by textile (3D) printing and/or by textile connecting devices.

Folded structures can also be introduced in the apparatus 10 and/or in the textile element 12 without actuation simply to maximize the absorbing (collecting) and/or discharging (evaporating) surface area of the apparatus 10 e.g. of the textile element 12. In this case the system is only passive. The amount of folding structures e.g. the size of their sections is unlimited.

1-38. (canceled)

39. An apparatus for absorbing precipitation water from rain events, especially from driving rain events, and for water discharge by evaporation, characterized by at least one textile element for absorbing water from rainwater drops and/or for discharging water by evaporation, wherein the textile element is designed as a three-dimensional textile structure, with a first, water-permeable layer and a second, water-guiding layer, wherein these layers are connected to one another by means of water-guiding, connecting threads, wherein the textile element is preferably fluidically connected to a water discharge conduit and/or to a water supply conduit.

40. The apparatus according to claim 39, wherein a water collecting device is provided which is flow-connected to the textile element and/or to the water discharge conduit.

41. The apparatus according to claim 39, wherein a water supply device is provided which is flow-connected to the textile element and/or to the water supply conduit.

42. The apparatus according to claim 39, wherein the apparatus and/or the textile element comprises hydrophilic and/or hydrophobic modifications.

43. The apparatus according to claim 39, wherein the textile element i.e. the three-dimensional textile structure is preferably formed from synthetic fibre, polymer fibre, glass fibre, metal fibre and/or other appropriate materials, being embodied as monofilaments or multifilaments.

44. The apparatus according to claim 39, wherein the first layer has a water-attracting and/or hydrophilic lamination, coating, finishing, filament shape optimization and/or that a water-attracting layer is applied to the first layer, wherein this layer and/or the first layer are of finer-pored design than the spacing structure formed by the connecting threads between the first layer and the second layer.

45. The apparatus according to claim 39, wherein the second layer has a water-guiding and/or hydrophobic lamination, coating, finishing and/or filament shape optimization and/or that a water-guiding layer is applied to the second layer, wherein this layer and/or the second layer are water-tight or perforated.

46. The apparatus according to claim 39, wherein the apparatus and/or the textile element are planar, curved, folded and/or adaptable in shape.

47. The apparatus according to claim 39, wherein the first layer and/or the second layer are actuatable by one or more actuators along a direction parallel to the plane of the first layer or the second layer, so that the first layer and the second layer can be displaced relatively to one another.

48. The apparatus according to claim 39, wherein the apparatus and/or the textile element comprise folding structures which divide the apparatus and/or the textile element into several foldable, folded, pivotable and/or rotatable sections.

49. The apparatus according to claim 48, wherein the folding structures have a mechanical substructure and/or are introduced into the textile element by means of additive or subtractive manufacturing methods e.g. printing on textile substrate fabric and/or in that the folding structures are embodied by textile connecting devices.

50. The apparatus according to claim 48, wherein actuators are provided, by means of which the foldable, folded, pivotable and/or rotatable sections can be operated.

51. The apparatus according to claim 39, wherein sensors are provided, by means of which climate and/or environmental data are recorded e.g. for a control unit.

52. The apparatus according to claim 50, wherein a control unit for operating and/or regulating the actuators is provided, wherein the control unit is configured in such a way that the apparatus and/or the textile element and/or sections thereof are oriented towards precipitation and/or solar radiation.

53. The apparatus according to claim 39, wherein a holding device is provided to which the components of the apparatus are attached or attachable.

54. The apparatus according to claim 40, wherein the water collecting device comprises a frame profile and/or a water storage for storing precipitation water.

55. The apparatus according to claim 39, wherein a filter for filtering precipitation water is provided, wherein the filter is integrated into the textile element and/or arranged in or on the water collecting device and/or in the building.

56. The apparatus according to claim 39, wherein a pump and/or a water temperature control device are provided, which are each flow connected with the water supply device and/or with the water collecting device.

57. The apparatus according to claim 40, wherein the water supply device and/or the water collecting device is connected to a heat exchanger.

58. A facade system for separating a building interior (inside) I from an exterior space (outside) O, including an apparatus according to claim 39, whereas the facade system is optionally constructed in one or more layers and/or modularly.

59. The facade system according to claim 58, wherein on the side on which the second textile layer of the textile element of the apparatus is located, the facade system has at least one fluid-flow-through layer and/or an insulation layer and/or an inner layer.

60. The facade system according to claim 58, wherein two fluid-flow-through layers are provided, wherein the first fluid-flow-through layer is arranged on one side of the insulation layer and the second fluid-flow-through layer is arranged on the other side of the insulation layer.

61. The facade system according to claim 58, wherein one of the two or both fluid-flow-through layers are configured and intended as a thermal collector and/or used for temperature control of the building interior wall surfaces, for regulation of the air humidity, for regulation of the acoustic and sound insulation properties and/or for active fire protection measures.

62. The facade system according to claim 58, wherein said further apparatus forming an inner layer of the facade system, wherein the first layer of the textile element of the further apparatus faces the building interior (inside) I.

63. The facade system according to claim 58, wherein the facade system comprises a preferably modular profile system to which the components of the facade system is attached or attachable.

64. A method for operating an apparatus according to claim 39, wherein precipitation water is supplied to a use in, on or outside the building. (New) A method for controlling and/or regulating an apparatus for absorbing and discharging water, in particular an apparatus according to claim 39, the method comprising the following steps:
retrieving forecast weather data from a weather service for a defined time period,
estimating the consumption of drinking water, raw water and/or grey water in, on or outside a building or civil engineering structure for the defined time period, e.g. by means of consumption analysis, and
comparing the estimated consumption of drinking water, raw water and/or grey water with expected precipitation water yields from the forecast weather data.
